(19) United States
(12) Patent Application Publication
(10) Pub. No.: US 2005/0266377 A1
(43) Pub. Date: Dec. 1, 2005

(54) Handpiece of dental scaler

(76) Inventor: Wen-Hsi Tsao, Taoyuan City (TW)

Correspondence Address: SUPREME PATENT SERVICES, POST OFFICE BOX 2339, SARATOGA, CA, 95070, US

(21) Appl. No.: 10/855,169

(22) Filed: May 26, 2004

(51) Int. Cl. A61C 3/03

(52) U.S. Cl. 433/119

(57) ABSTRACT

A handpiece of a dental scaler includes an outer sheath and an inner housing received in the outer sheath. An inner surface of the outer sheath forms an inclined section converging toward an end of the sheath. An end of the inner housing is reduced and is complementary in shape to the converged inner surface of the outer sheath whereby a surface contact is formed between the outer sheath and the inner housing. A circumferential groove is defined in the reduced end of the inner housing to receive an O-ring. An inner-threaded fastener is threadingly fixed to an opposite, threaded end of the outer sheath and has an inner shoulder engaging a step formed in the inner housing thereby inducing an axial linear movement on the inner housing with respect to the outer sheath to compress and deform the O-ring for securing watertightness between the outer sheath and the inner housing.

### BACKGROUND OF THE INVENTION

1. Field of the Invention

The present invention relates generally to a dental scaler, and in particular to a handpiece of the dental scaler having an exchangeable outer sheath for easy disinfection and sterilization and an extended service life.

2. The Related Art

Ultrasonic dental scalers are known and commonly employed to remove calculus from a patient's teeth by means of a scaling tool vibrating at ultrasonic frequencies. The ultrasonic dental scaler comprises a handpiece coupled to dental scaler electronics by a cable. The handpiece comprises an outer sheath in which a scaling tool is received and removably fixed. An example is shown in U.S. Pat. No. 5,382,162, wherein a dental scaler is comprised of an inner housing received in an outer sheath. The device disclosed in the US patent suffers a variety of drawbacks, which will be briefly discussed in the followings paragraphs.

The outer sheath of the device disclosed in the US patent is configured to facilitate gripping by an operator. The outer sheath is coupled to the inner housing of the dental scaler by means of mated inner threading and outer threading respectively formed in the outer sheath and the inner housing. In order to maintain a substantially continuous gripping shape, the threading is provided on surfaces independent of any exposed surface of the outer sheath. Therefore, fixing the outer sheath and the inner housing together must be done by threads arranged inside the outer sheath. In other words, the outer sheath must be rotated and thus threadingly engaging the inner housing to secure the outer sheath to the inner housing. Design flexibility is thus subject to the constraint of arranging the threads inside the sheath.

The outer sheath is designed to be autoclaveable and autoclaving causes the outer sheath to shrink. Thus, the threading of the outer sheath must be designed to be originally slightly oversized in order to compensate for the shrinkage. This complicates the design and manufacturing process of the outer sheath.

In order to eliminate potential risk of electric shock, watertight sealing is provided between the inner housing and the outer sheath. Since the inner housing and the sheath are fixed together by threading engagement between inner threading formed inside the sheath and external threading formed around an outer surface of the inner housing, the engagement is done by rotating the sheath and the inner housing with respect to each other. Such a rotation leads to abrasion of the sealing member arranged between the sheath and the inner housing due to the friction force caused by the relative rotation between the sheath and the inner housing. The abrasion cause damage to the sealing member and deteriorates watertightness of the seal whereby potential risk of electric shock is increased.

In addition, using a watertight sealing ring, such as an O-ring, to seal between opposite cylindrical surfaces is known. The device disclosed in the US patent arranges an O-ring, serving as a watertight sealing member, between a ring-shaped space between a cylindrical portion of the inner housing and a cylindrical inside surface of the outer sheath. The cylindrical inside surface of the outer sheath is elongated in an axial direction, which allows watertightness to be established between the cylindrical portion of the inner housing and the cylindrical inside surface of the outer sheath even when the inner housing and the outer sheath is loosely coupled, not completely secured. Such a design suffers the drawback that the watertightness deteriorates when the sealing member is subject to abrasion or aging.

Thus, it is desired to have a dental scaler device that effectively eliminates the risk of electric shock caused by damaged sealing, while overcoming the drawbacks of the prior art design.

### SUMMARY OF THE INVENTION

Therefore, a primary object of the present invention is to provide a hand piece of dental scaler with exchangeable outer sheath for easy disinfection and sterilization comprising an inner housing that is securely fixed inside an outer sheath without relative rotation therebetween so as to completely eliminate abrasion induced in a watertight sealing between the housing and sheath and thus preserving the watertightness of the sealing after repeated assembling/disassembling.

Another object of the present invention is to provide a handpiece of dental scaler having an enhanced watertight sealing between an inner housing and an outer sheath by providing the outer sheath with an inclined inner wall section whereby deterioration of watertightness can be effectively eliminated even when a sealing member is subject to abrasion and aging.

A further object of the present invention is to provide a handpiece of dental scaler comprising an inner housing received in an outer sheath wherein the inner housing is secured inside the outer sheath by an end member that forms an inner-threaded fastener engaging an external threading of the outer sheath whereby since the inner housing is not directly threadingly coupled to the outer sheath, shrinkage caused by autoclaving between the outer sheath and the inner housing can be eliminated.

To achieve the above objects, in accordance with the present invention, there is provided a handpiece of dental scaler comprising an outer sheath and an inner housing received in the outer sheath. An inner surface of the outer sheath forms an inclined section converging toward an end of the sheath. An end of the inner housing is reduced and is complementary in shape to the converged inner surface of the outer sheath whereby a surface contact is formed between the outer sheath and the inner housing. A circumferential groove is defined in the reduced end of the inner housing to receive an O-ring. An inner-threaded fastener is threadingly fixed to an opposite, threaded end of the outer sheath and has an inner shoulder engaging a step formed in the inner housing thereby inducing an axial linear movement on the inner housing with respect to the outer sheath to compress and deform the O-ring for securing watertightness between the outer sheath and the inner housing.

### BRIEF DESCRIPTION OF THE DRAWINGS

The present invention will be apparent to those skilled in the art by reading the following description of preferred embodiments thereof, with reference to the attached drawings, in which:

FIG. 1 is a side elevational view of a handpiece of a dental scaler constructed in accordance with the present invention;

FIG. 2 is an exploded view of the handpiece of the present invention; and

FIG. 3 is a cross-sectional view of the handpiece of the present invention.

### DETAILED DESCRIPTION OF THE PREFERRED EMBODIMENT

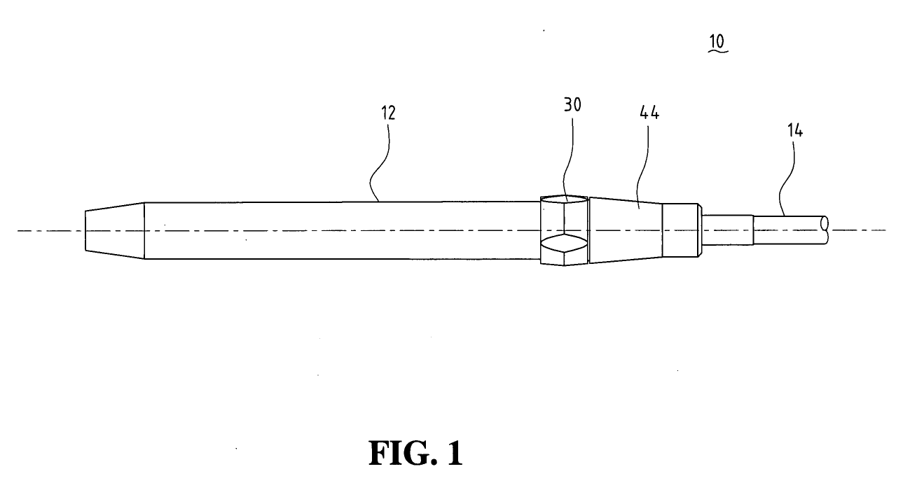

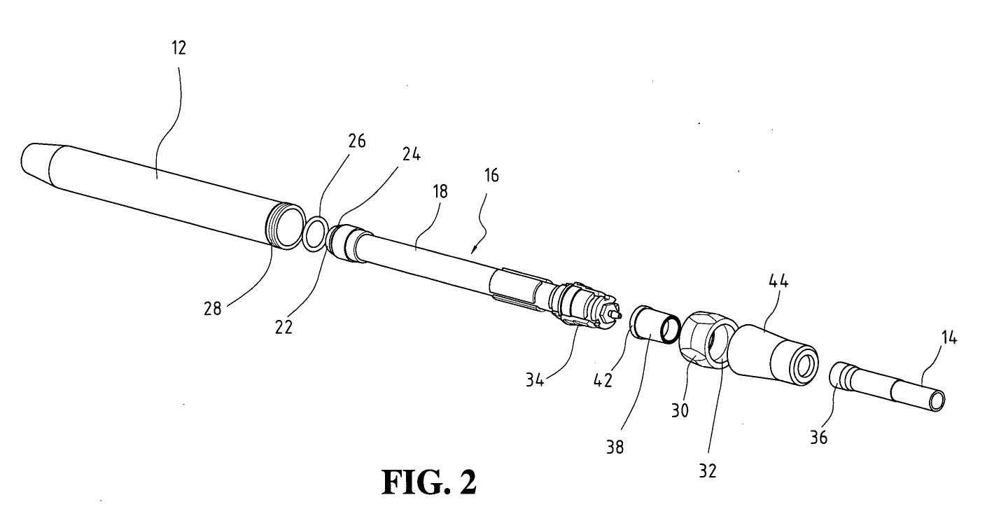

With reference to the drawings and in particular to FIGS. 1 and 2, a handpiece of a dental scaler in accordance with the present invention, generally designated with reference numeral 10, comprises an outer sheath 12 having a front end and a rear end (both not labeled) and a flexible cable 14 having a proximal end (not labeled) coupled to the rear end of the outer sheath 12. The flexible cable 14 extends to dental scaler electronics (not shown) for electrically and mechanically coupling the handpiece 10 to the dental scaler electronics. The flexible cable 14 may enclose a water hose (not shown) that delivers water for cooling parts of the handpiece and electrical wires (not shown) for transmission of electrical signals from the dental scaler electronics to the handpiece 10. This is known and constitutes no novel part of the present invention and thus no further detail is needed herein.

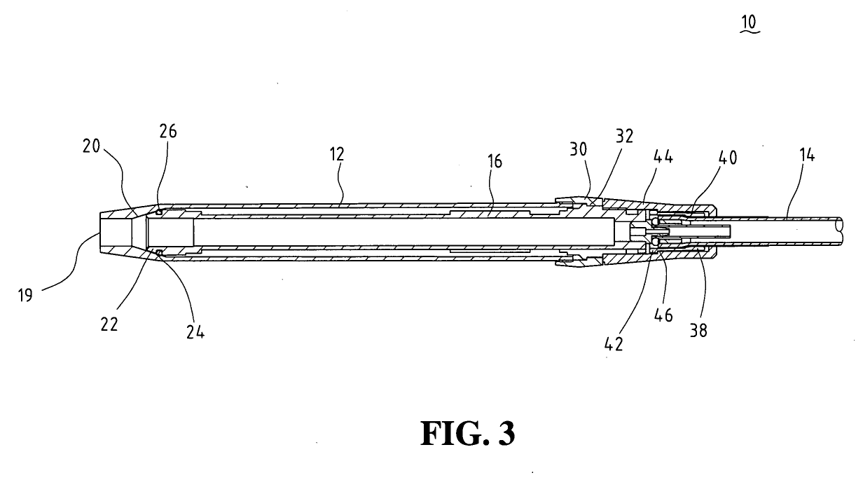

Also referring to FIG. 3, the outer sheath 12 is a hollow cylinder receiving a tubular inner housing 16 therein, both being substantially concentric. The inner housing 16 has an outside surface in which a circumferential recessed portion 18 is formed to receive a coil or winding (not shown for clarity) thereon. The coil is electrically coupled to the electrical wires of the cable 14 to receive the electrical signals from the dental scaler electronics. This is also known and no further detail will be given herein.

The outer sheath 12 forms a front opening 19 (see FIG. 3) through which a scaler insert (not shown) extends. The scaler insert is partially received in the tubular inner housing 16 whereby high frequency vibration is induced on the scaler insert by the coil that receives the electrical signals from the dental scaler electronics to perform scaling operation.

The outer sheath 12 has an inclined inner wall section 20, which converges toward the front opening 19 of the sheath 12. Corresponding to the inclined inner wall section 20, a front end 22 of the inner housing 16 is gradually reduced whereby the front end 22 of the inner housing 16 forms a converging configuration having the same inclination as the inclined wall section 20 of the outer sheath 12 whereby a surface contact may be formed between the front end 22 of the inner housing 16 and the inclined inner wall section 20 of the outer sheath 12, which limits relative linear movement of the inner housing 16 with respect to the outer sheath 12 in the axial direction thereby retaining the inner housing 16 in the outer sheath 12.

A circumferential groove 24 is defined in the converging end 22 of the inner housing 16. An O-ring seal 26 is received in the groove 24 and tightly engages the inclined inner wall section 20 of the outer sheath 12, securing watertightness between the outer sheath 12 and the inner housing 16.

The rear end of the outer sheath 12 is threaded, see reference numeral 28, to which an inner-threaded fastener 30, such as a nut, engages. The fastener 30 forms an inner shoulder 32 that engages a step 34 formed on the inner housing 16 adjacent a rear end of the housing 16 and extending in a circumferential direction. Tightening the fastener 30 on the threaded end 28 of the outer sheath 12 induces an axial driving force on the inner housing 16 by the engagement between the shoulder 32 of the fastener 30 and the step 34 of the inner housing 16, which compresses the O-ring seal 26 against the inclined inner wall section 20 of the outer sheath 12, causing deformation of the O-ring seal 26 and thereby ensuring watertightness between the inner housing 16 and the outer sheath 12. Even when the O-ring seal 26 is subject to quality variation, such as abrasion and aging, the watertightness can still be maintained e by simply further tightening the fastener 30.

Since watertightness is provided by compressing the O-ring seal 26 against the inclined inner wall section 20 of the sheath 12 by axial linear movement, rather than rotation against the O-ring, risk of damage caused on the O-ring seal 26 by the tightening operation is substantially reduced and thus the service life of the O-ring seal 26 can be extended.

By using the fastener 30 to secure the outer sheath 12 to the inner housing 16, the outer sheath 12 is not fixed to the inner housing 16 by direct threading engagement therebetween. This eliminates the potential problem of shrinkage caused by separately autoclaving the outer sheath 12 for the fastener 30 and the outer sheath 12 can be autoclaved together.

The proximal end of the flexible cable 14 forms a circumferential expansion 36. A cable retainer 38, in the form of a hollow cylinder, is fit over the proximal end of the cable 14. The retainer 38 has an inner surface forming a circumferential shoulder 40 that engages an axial end of the expansion 36 and an outer surface forming a circumferential flange 42. A cable coupler 44, which is tubular, is completely fit over the cable retainer 38 and has a first end partially overlapping and fixed to the rear end of the inner housing 16. The coupler 44 forms an inner shoulder 46 engaging the flange 42 of the cable retainer 38 thereby securing the cable retainer 38 and the proximal end of the cable 14 to the rear end of the inner housing 16. Fixing the coupler 44 to the rear end of the inner housing 16 can be done by any known means, such as threading.

Alternatively, the cable coupler 44 that is threadingly fixed to the inner housing 16 to attach the proximal end of the flexible cable 14 to the rear end of the inner housing 14 and the fastener 30 that is threadingly fixed to the outer sheath 12 to fix the inner housing 16 inside the outer sheath 12 can be combined as a unitary member whereby by for example threadingly fixing the unitary member to the outer sheath 12, both attaching the flexible 14 to the inner housing 16 and fixing the inner housing 16 inside the outer sheath 12 can be simultaneously done by a single operation.

Although using an inner-threaded fastener 30, which threadingly engages an external threading 28 of the outer sheath 12, to secure the outer sheath 12 to the inner housing 16 sacrifices the provision of a continuous gripping surface as indicated in the previously cited US patent, yet design flexibility is enhanced as there is no need to take for example the shrinkage problem into consideration. Further, attaching the cable 14 to the dental scaler can be made easier as compared to the previously cited US patent.

Although the present invention has been described with reference to the preferred embodiments thereof, it is apparent to those skilled in the art that a variety of modifications and changes may be made without departing from the scope of the present invention which is intended to be defined by the appended claims.

1. A handpiece of a dental scaler comprising:
an outer sheath having an inner surface;
an inner housing adapted to receive a scaler insert, received in the outer sheath and having an outer surface corresponding to the inner surface of the outer sheath; and
a sealing member arranged between the inner surface of the outer sheath and the outer surface of the inner housing;
wherein watertightness is secured by deformation of the sealing member solely caused by relative axial linear movement between the inner housing and outer sheath.

2. The handpiece as claimed in claim 1, wherein the inner surface of the outer sheath converges toward an end of the outer sheath having a predetermined inclination, the outer surface of the inner housing being reduced with the same inclination toward a corresponding end whereby a surface contact engagement is established between the inner surface of the outer sheath and the outer surface of the inner housing.

3. The handpiece as claimed in claim 2, wherein a circumferential groove is defined in the outer surface of the inner housing and wherein the sealing member comprises an O-ring received in the groove.

4. The handpiece as claimed in claim 3 further comprising an inner-threaded fastener having an inner shoulder engaging a step formed in the inner housing, the fastener being threadingly engaging an end of the outer sheath to induce the relative axial movement between the inner housing and the outer sheath.

5. The handpiece as claimed in claim 4, wherein the inner surface of the outer sheath converges toward an end of the outer sheath having a predetermined inclination, the outer surface of the inner housing being reduced with the same inclination toward a corresponding end whereby a surface contact engagement is established between the inner surface of the outer sheath and the outer surface of the inner housing.

6. The handpiece as claimed in claim 5, wherein a circumferential groove is defined in the outer surface of the inner housing and wherein the sealing member comprises an O-ring received in the groove.

7. The handpiece as claimed in claim 1 further comprising a flexible cable having a proximal end attached to a rear end of the inner housing.

8. The handpiece as claimed in claim 7, wherein the proximal end of the cable forms an expanded section extending through a tubular cable retainer, the cable retainer forming an inner shoulder engaging an axial end of the expanded section of the cable, a tubular cable coupler fit over the cable retainer and fixed to the inner housing, the coupler having an inner shoulder engaging an outer flange of the cable retainer to fix the cable retainer and the proximal end of the cable to the rear end of the inner housing.

9. The handpiece as claimed in claim 8, wherein the inner surface of the outer sheath converges toward an end of the outer sheath having a predetermined inclination, the outer surface of the inner housing being reduced with the same inclination toward a corresponding end whereby a surface contact engagement is established between the inner surface of the outer sheath and the outer surface of the inner housing.

10. The handpiece as claimed in claim 9, wherein a circumferential groove is defined in the outer surface of the inner housing and wherein the sealing member comprises an O-ring received in the groove.

11. A handpiece of a dental scaler comprising:
an outer sheath having an inclined inner surface and an outer surface forming external threading;
an inner housing adapted to receive a scaler insert, received in the outer sheath and having an outer surface corresponding to the inner surface of the outer sheath;
a sealing member arranged between the inclined inner surface of the outer sheath and the outer surface of the inner housing; and
an inner-threaded fastener engageable with the external threading of the outer sheath to secure to outer sheath and the inner housing together;
wherein watertightness is secured by deformation of the sealing member solely caused by relative axial linear movement between the inner housing and outer sheath induced by tightening the inner-threaded fastener on the outer sheath.

12. The handpiece as claimed in claim 11, wherein the outer surface of the inner housing is gradually reduced with an inclination corresponding to the inclined inner surface of the outer sheath whereby a surface contact engagement is established between the inclined inner surface of the outer sheath and the gradually reduced outer surface of the inner housing.

13. The handpiece as claimed in claim 12, wherein a circumferential groove is defined in the outer surface of the inner housing and wherein the sealing member comprises an O-ring received in the groove.

14. The handpiece as claimed in claim 13, wherein the inner-threaded fastener having an inner shoulder engaging a step formed in the inner housing whereby tightening the fastener on the outer sheath induces the relative axial movement between the inner housing and the outer sheath.
